(19) United States
(12) Patent Application Publication
(10) Pub. No.: US 2014/0057177 A1
(43) Pub. Date: Feb. 27, 2014

(54) COMPOSITE PRECURSOR, COMPOSITE PREPARED THEREFROM, METHOD OF PREPARING THE COMPOSITE, POSITIVE ELECTRODE FOR LITHIUM SECONDARY BATTERY INCLUDING THE COMPOSITE, AND LITHIUM SECONDARY BATTERY EMPLOYING THE POSITIVE ELECTRODE

(71) Applicant: SAMSUNG SDI CO., LTD., Yongin-si (KR)

(72) Inventors: Jun-Seok Park, Yongin-si (KR); Yong-Chan You, Yongin-si (KR); Chang-Wook Kim, Yongin-si (KR); Jae-Hong Lim, Yongin-si (KR); Sang-Woo Cho, Yongin-si (KR); Ji-Hyun Kim, Yongin-si (KR)

(73) Assignee: SAMSUNG SDI CO., LTD., Yongin-si (KR)

(21) Appl. No.: 13/837,183

(22) Filed: Mar. 15, 2013

(30) Foreign Application Priority Data
Aug. 23, 2012 (KR) 10-2012-0092538

(51) Int. Cl. H01M 4/36

(52) U.S. Cl. CPC H01M 4/364
USPC 429/220; 429/223; 429/221; 252/182.1

(57) ABSTRACT

A composite precursor is represented by Formula 1, and includes primary particles having an average particle diameter of about 1 nm to about 10 nm. A composite is prepared from the composite precursor. A method of preparing the composite includes mixing the composite precursor with a lithium compound to obtain a mixture, and thermally treating the mixture to obtain the composite. A positive electrode for a lithium secondary battery includes the composite, and a lithium secondary battery includes the positive electrode.

NiₐMn_{b}Co_{c}M_{d}(CO₃)₂ Formula 1

### CROSS-REFERENCE TO RELATED APPLICATION

This application claims priority to and the benefit of Korean Patent Application No. 10-2012-0092538, filed on Aug. 23, 2012 in the Korean Intellectual Property Office, the entire content of which is incorporated herein by reference.

### BACKGROUND

1. Field

One or more embodiments of the present invention relate to a composite precursor, a composite prepared from the composite precursor, a positive electrode for a lithium secondary battery including the composite, and a lithium secondary battery including the positive electrode.

2. Description of the Related Art

Recently, use of lithium secondary batteries in mobile phones, camcorders, and laptop computers has been rapidly increasing. The capacity of a lithium secondary battery is influenced by the positive active material. The long-term usability of a lithium secondary battery at high rates and the ability to maintain initial capacity over many charge/discharge cycles depends on the electrochemical characteristics of the positive active material.

Lithium composite oxides such as lithium nickel composite oxides or lithium cobalt oxide have been widely used as positive active materials for lithium secondary batteries. However, the lithium composite oxides developed so far do not have satisfactory capacity, and thus, there is still a need for improvement.

### SUMMARY

According to one or more embodiments of the present invention, a composite precursor has a controlled average particle diameter. In other embodiments, a composite is prepared from the composite precursor, a positive electrode for lithium secondary batteries includes the composite, and a lithium secondary battery includes the positive electrode. Additional aspects will be set forth in part in the description which follows and, in part, will be apparent from the description, or may be learned by practice of the described embodiments.

According to one or more embodiments of the present invention, a composite precursor is represented by Formula 1 below, in which primary particles of the composite precursor have an average diameter of about 1 nm to about 10 nm.

NiₐMn_{b}Co_{c}M_{d}(CO₃)₂ Formula 1

In Formula 1, 0<a≦0.5, 0<b≦0.8, 0<c≦0.5, and 0≦d≦0.20. M is at least one metal selected from titanium (Ti) vanadium (V), chromium (Cr), iron (Fe), copper (Cu), aluminum (Al), magnesium (Mg), zirconium (Zr), and boron (B).

According to one or more embodiments of the present invention, a method of preparing a composite represented by Formula 2 below includes: mixing a composite precursor represented by Formula 1 below with a lithium compound to obtain a mixture, and thermally treating the mixture to obtain the composite.

NiₐMn_{b}Co_{c}M_{d}(CO₃)₂ Formula 1

In Formula 1, 0<a≦0.5, 0<b≦0.8, 0<c≦0.5, and 0≦d≦0.20. M is at least one metal selected from titanium (Ti) vanadium (V), chromium (Cr), iron (Fe), copper (Cu), aluminum (Al), magnesium (Mg), zirconium (Zr), and boron (B).

xLi₂MnO₃-(1-x)Li_{y}NiₐMn_{b}CoN_{d}O₂ [Formula 2]

In Formula 2, 0<x≦0.8, 0.7≦y≦1.3, 0<a≦0.5, 0<b≦0.8, 0<c≦0.5, and 0≦d≦0.20. M is at least one metal selected from titanium (Ti) vanadium (V), chromium (Cr), iron (Fe), copper (Cu), aluminum (Al), magnesium (Mg), zirconium (Zr), and boron (B).

According to one or more embodiments of the present invention, a positive electrode for a lithium secondary battery includes the composite represented by Formula 2 above.

According to one or more embodiments of the present invention, a lithium secondary battery includes the above-described positive electrode, an anode, and a separator between the positive electrode and the anode.

### BRIEF DESCRIPTION OF THE DRAWINGS

These and/or other aspects will be better understood from the following detailed description of the embodiments when taken in conjunction with the accompanying drawings, in which:

FIG. 1 is a perspective, cross-sectional view of a lithium secondary battery according to an embodiment of the present invention;

FIG. 2 is a scanning electron microscope (SEM) image of the composite precursor prepared according to Example 1;

FIG. 3 is an SEM image of the composite precursor prepared according to Comparative Example 1;

FIG. 4 is a graph comparing the X-ray diffraction (XRD) analysis results for the composite precursors of Example 1 and Comparative Example 1;

FIG. 5 is a graph comparing the XRD analysis results for composites of Example 2 and Comparative Example 2; and

FIGS. 6A and 6B are graphs of the charge-discharge characteristics with respect to rate in the coin cells manufactured according to Manufacture Example 1 and Comparative Manufacture Example 1.

### DETAILED DESCRIPTION

In this detailed description, reference will be made to certain embodiments, examples of which are illustrated in the accompanying drawings, and like reference numerals refer to like elements throughout. In this regard, the described embodiments are exemplary, and those or ordinary skill in the art would recognize that changes may be made to the described embodiments without departing from the scope of the invention. As such, the present invention should not be construed as limited to the described embodiments set forth herein. Indeed, the embodiments described herein are described with reference to the figures to explain certain aspects of embodiments of the present invention. As used herein, the term “and/or” includes any and all combinations of one or more of the associated listed items. Expressions such as “at least one of,” when preceding a list of elements, modify the entire list of elements and do not modify the individual elements of the list.

According to one or more embodiments of the present invention, a composite precursor is represented by Formula 1 below, in which primary particles of the precursor have an average diameter of about 1 nm to about 10 nm.

NiₐMn_{b}Co_{c}M_{d}(CO₃)₂ Formula 1

In Formula 1 above, 0<a≦0.5, 0<b≦0.8, 0<c≦0.5, and 0≦d≦0.20. M is at least one metal selected from titanium (Ti) vanadium (V), chromium (Cr), iron (Fe), copper (Cu), aluminum (Al), magnesium (Mg), zirconium (Zr), and boron (B).

In some embodiments, for example, in Formula 1, 0<a≦0.22, 0<b≦0.66, 0<c≦0.20, and 0≦d≦0.10.

The composite precursor may have high tap density, for example, about 1.55 to about 1.8 g/cc.

X-ray diffraction spectra of the composite precursor obtained using Cu—Kα X-rays may include a peak with a full width at half maximum (FWHM) of about 0.21 to 0.30° at a 2θ of 32±2°.

In one or more embodiments of the present invention, a composite is represented by Formula 2 below, in which the X-ray diffraction spectra of the composite obtained using Cu—Kα X-rays include a peak with a FWHM of about 0.14 to 0.16° at a 2θ of 19±2°.

xLi₂MnO₃-(1-x)Li_{y}NiₐMn_{b}Co_{c}N_{d}O₂ Formula 2

In Formula 2, 0<x≦0.8, 0.7≦y≦1.3, 0<a≦0.5, 0<b≦0.8, 0<c≦0.5, and 0≦d≦0.20. M is at least one metal selected from titanium (Ti) vanadium (V), chromium (Cr), iron (Fe), copper (Cu), aluminum (Al), magnesium (Mg), zirconium (Zr), and boron (B).

The composite may have a high pellet density, for example, about 2.4 to about 2.6 g/cc.

In some embodiments, in Formula 2, 0<a≦0.22, 0<b≦0.66, 0<c≦0.20, and 0≦d≦0.10.

The composite of Formula 2 may be, for example, 0.5Li₂MnO₃-0.5LiNi_{0.44}Co_{0.24}Mn_{0.32}O₂.

Hereinafter, embodiments of the composite precursor of Formula 1 and a method of preparing a composite represented by Formula 2 from the composite precursor will now be described.

For example, the compound represented by Formula 2 may be obtained by mixing the composite precursor of Formula 1 with a lithium compound and thermally treating the resulting mixture.

Nonlimiting examples of the lithium compound include lithium hydroxide, lithium fluoride, lithium carbonate, and mixtures thereof. An amount of the lithium compound may be stoichiometrically controlled to obtain the composite of Formula 2.

The thermal treatment may be performed at a temperature of about 700° C. to about 900° C. When the thermal treatment temperature is within this range, forming the lithium composite oxide may be facilitated.

The thermal treatment may be performed in an air atmosphere.

The composite precursor of Formula 1 above may be obtained, for example, by mixing a nickel precursor, a cobalt precursor, a manganese precursor, a metal (M) precursor, and a solvent to prepare a precursor mixture; adding an acidic ammonium-containing compound (as a chelating agent), and sodium carbonate (as a pH adjusting agent) to the precursor mixture; and co-precipitating the resulting mixture.

The pH adjusting agent may adjust the pH of the mixture to about 7 to about 9, thereby facilitating precipitation.

The chelating agent may control the rate of the precipitation reaction. One non-limiting example of the chelating agent is ammonium carbonate. Ammonium carbonate (as the chelating agent) does not significantly affect the pH of the mixture, and may be used in larger amounts as compared with ammonium hydroxide (which is also available as the chelating agent). Using an increased amount of the chelating agent as compared with common methods may control the size of secondary particles of the composite precursor obtained via the co-precipitation to about 5 μm to about 10 μm. The composite precursor having an average particle diameter within this range may have high tap density, and a composite prepared using this composite precursor may have high pellet density. Therefore, a lithium secondary battery with improved capacity may be manufactured using the composite.

Nonlimiting examples of the metal (M) precursor include metal (M) sulfates, metal (M) nitrates, and metal (M) chlorides.

In this regard, M may be at least one metal selected from titanium (Ti) vanadium (V), chromium (Cr), iron (Fe), copper (Cu), aluminum (Al), magnesium (Mg), zirconium (Zr), and boron (B).

Nonlimiting examples of the nickel precursor include nickel sulfate, nickel nitrate, and nickel chloride. Nonlimiting examples of the cobalt precursor include cobalt sulfate, cobalt nitrate, and cobalt chloride. Nonlimiting examples of the manganese precursor include manganese sulfate, manganese nitrate, and manganese chloride.

The amount of the metal (M) precursor may be stoichiometrically controlled to obtain the composite precursor of Formula 1 above.

Nonlimiting examples of the solvent include ethanol and deionized water. The amount of the solvent may be about 300 parts to about 1000 parts by weight based on 100 parts by weight of the nickel precursor. When the amount of the solvent is within this range, the homogeneous precursor mixture may be obtained.

The pH of the resulting mixture may be controlled to about 7 to about 9 by adjusting the amount of the pH adjusting agent.

The precipitate from the resulting mixture may be washed with pure water and dried to obtain the composite precursor of Formula 1 above.

In some embodiments, the composite of Formula 2 above may be used as a positive active material for lithium secondary batteries.

When the composite is used as the positive active material of a lithium battery, the positive electrode may have improved density and capacity characteristics. This positive electrode may be used to manufacture a lithium secondary battery with improved charge-discharge characteristics and high rate characteristics.

Hereinafter, a method of manufacturing a lithium secondary battery including the composite of Formula 2 above as a positive active material will be described. The lithium secondary battery includes a positive electrode, a negative electrode, a lithium salt-containing non-aqueous electrolyte, and a separator.

The positive electrode may be fabricated by coating a positive active material layer composition on a current collector and drying the resulting product. Similarly, the negative electrode may be fabricated by coating a negative active material layer composition on a current collector and drying the resulting product.

The positive active material layer composition may be prepared by mixing a positive active material, a conducting agent, a binder, and a solvent, and the positive active material may be the composite of Formula 2 above.

The binder facilitates the binding of components (such as the positive active material and the conducting agent) to each other, and the binding of the positive active material layer to the current collector. The amount of the binder may be about 1 part to about 50 parts by weight based on 100 parts by weight of the total weight of the positive active material.

Nonlimiting examples of the binder include polyvinylidene fluoride (PVDF), polyvinyl alcohols, carboxymethylcellulose (CMC), starch, hydroxypropylcellulose, regenerated cellulose, polyvinylpyrrolidone, polytetrafluoroethylene, polyethylene, polypropylene, ethylene-propylene-diene terpolymer (EPDM), sulfonated EPDM, styrene butadiene rubber, fluoro rubber, and various copolymers. The amount of the binder may be about 2 parts to about 5 parts by weight based on 100 parts by weight of the total weight of the positive active material. When the amount of the binder is within this range, the positive active material layer may bind strongly to the current collector.

The conducting agent is not particularly limited, and may be any suitable material that has appropriate conductivity but that does not cause a chemical change in the fabricated battery. Nonlimiting examples of the conducting agent include graphite (such as natural or artificial graphite); carbonaceous materials (such as carbon black, acetylene black, ketjen black, channel black, furnace black, lamp black, and thermal black); conductive fibers (such as carbon fibers and metallic fibers); metallic powders (such as aluminum powder, and nickel powder); conductive whiskers (such as zinc oxide and potassium titanate); conductive metal oxides (such as titanium oxide); and other conductive materials (such as polyphenylene derivatives).

The amount of the conducting agent may be about 2 parts to about 5 parts by weight based on 100 parts by weight of the total weight of the positive active material. When the amount of the conducting agent is within this range, the negative electrode may have improved conductive characteristics.

A non-limiting example of the solvent is N-methylpyrrolidone (NMP).

The amount of the solvent may be about 1 part to about 10 parts by weight based on 100 parts by weight of the positive active material. When the amount of the solvent is within this range, formation of the positive active material layer may be facilitated.

The positive electrode current collector may have a thickness of about 3 μm to about 500 μm, and may be any current collector having high conductivity but that does not cause a chemical change in the fabricated battery. Nonlimiting examples of the positive electrode current collector include stainless steel, aluminum, nickel, titanium, thermal-treated carbon, and aluminum or stainless steel that is surface-treated with carbon, nickel, titanium, or silver. The positive electrode current collector may be processed to have fine irregularities on its surface so as to enhance the adhesive strength of the current collector to the positive active material. The positive electrode current collector may take any of various forms, including a film, a sheet, a foil, a net, a porous structure, a foam, and a non-woven fabric.

Apart from the positive active material layer composition prepared above, the composition for forming the negative active material layer includes a negative active material, a binder, a conducting agent, and a solvent.

The negative active material may be a material that allows intercalation and deintercalation of lithium ions. Nonlimiting examples of the negative active material include graphite, carbon, lithium metal, lithium alloys, and silicon oxide-based materials. In one embodiment, the negative active material may be silicon oxide.

The amount of the binder may be about 1 part to about 50 parts by weight based on 100 parts by weight of the total weight of the negative active material. Nonlimiting examples of the binder include those described above in connection with the positive electrode.

The amount of the conducting agent may be about 1 part to about 5 parts by weight based on 100 parts by weight of the negative active material. When the amount of the conducting agent is within this range, the negative electrode may have improved conductive characteristics.

The amount of the solvent may be about 1 part to about 10 parts by weight based on 100 parts by weight of the negative active material. When the amount of the solvent is within this range, formation of the negative active material layer may be facilitated.

The same kinds of conducting agents and solvents as those used in the positive electrode may be used in the negative electrode.

The negative electrode current collector may have a thickness of about 3 μm to about 500 μm. The negative electrode current collector is not particularly limited, and may be any material with an appropriate conductivity but that does not cause a chemical change in the fabricated battery. Nonlimiting examples of the negative electrode current collector include copper, stainless steel, aluminum, nickel, titanium, thermal-treated carbon, copper or stainless steel that is surface-treated with carbon, nickel, titanium or silver, and aluminum-cadmium alloys. In addition, similar to the positive electrode current collector, the negative electrode current collector may be processed to have fine irregularities on its surface so as to enhance the adhesive strength of the negative electrode current collector to the negative active material. Also, the negative electrode current collector may take any of various forms, including a film, a sheet, a foil, a net, a porous structure, a foam, and a non-woven fabric.

The separator is disposed between the positive and negative electrodes, which are manufactured according to the processes described above.

The separator may have a pore diameter of about 0.01 to about 10 μm fill and a thickness of about 5 to about 300 μm. Nonlimiting examples of the separator include olefin-based polymers, such as polypropylene or polyethylene, glass fiber sheets, and non-woven fabrics. When a solid electrolyte is used, for example, a polymer electrolyte, the solid electrolyte may also serve as the separator.

The lithium salt-containing non-aqueous electrolyte includes a non-aqueous electrolyte solution and a lithium salt. The non-aqueous electrolyte may be a non-aqueous liquid electrolyte, an organic solid electrolyte, or an inorganic solid electrolyte.

Nonlimiting examples of the non-aqueous liquid electrolyte include aprotic organic solvents such as N-methyl-2-pyrrolidone, propylene carbonate, ethylene carbonate (EC), butylene carbonate, dimethyl carbonate, diethyl carbonate (DEC), fluoroethylene carbonate (FEC), γ-butyrolactone, 1,2-dimethoxy ethane, tetrahydrofuran, 2-methyl tetrahydrofuran, N,N-dimethylsulfoxide, 1,3-dioxolane, formamide, N,N-dimethylformamide, acetonitrile, nitromethane, methyl formate, methyl acetate, phosphoric acid trimester, trimethoxy methane, sulfolane, methyl sulfolane, 1,3-dimethyl-2-imidazolidinone, propylene carbonate derivatives, ether, methyl propionate, and ethyl propionate.

Nonlimiting examples of the organic solid electrolyte include polyethylene derivatives, polyethylene oxide derivatives, polypropylene oxide derivatives, phosphoric acid ester polymers, polyvinyl alcohols, and polyvinylidene fluoride.

Nonlimiting examples of the inorganic solid electrolyte include nitrates, halides and sulfates of lithium such as Li₃N, LiI, Li₅NI₂, Li₃N—LiI—LiOH, Li₂SiS₃, Li₄SiO₄, Li₄SiO₄—LiI—LiOH, and Li₃PO₄—Li₂S—SiS₂.

The lithium salt may be any lithium salt that is soluble in the above-mentioned non-aqueous electrolyte. Nonlimiting examples of the lithium salt include LiCl, LiBr, LiI, LiClO₄, LiBF₄, LiB₁₀Cl₁₀, LiPF₆, LiCF₃SO₃, LiCF₃CO₂, LiAsF₆, LiSbF₆, LiAlCl₄, CH₃SO₃Li, CF₃SO₃Li, (CF₃SO₂)₂NLi, lithium chloroborate, lithium lower aliphatic carboxylate, and lithium tetraphenyl borate.

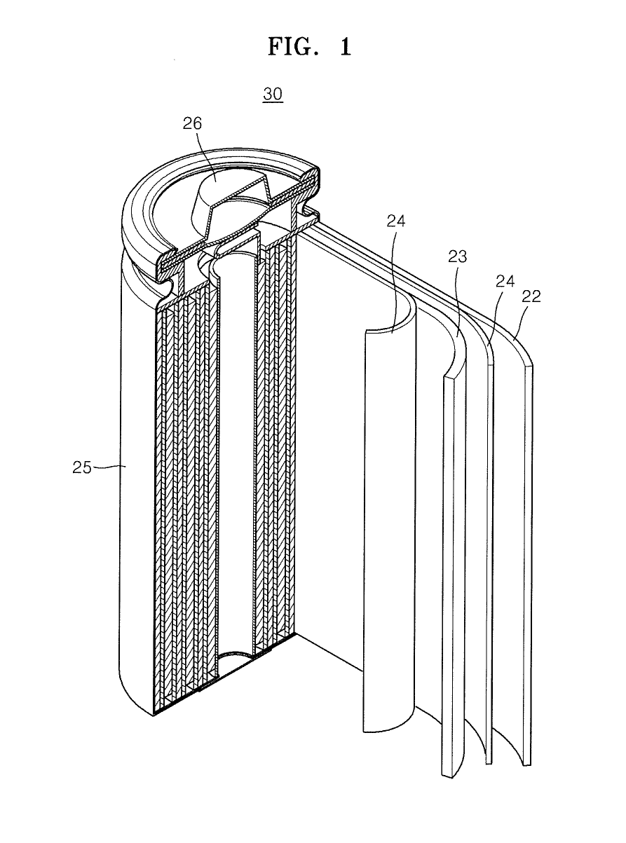

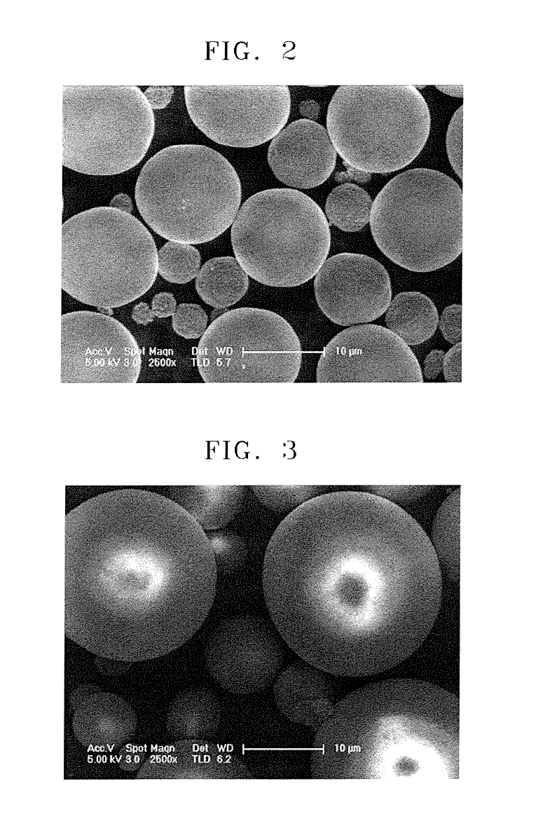

FIG. 1 is a schematic perspective view of a lithium secondary battery 30 according to an embodiment of the present invention. Referring to FIG. 2, the lithium secondary battery 30 includes an electrode assembly including a positive electrode 23, a negative electrode 22, and a separator 24 between the positive electrode 23 and the negative electrode 22. The electrode assembly is contained within a battery case 25, and a sealing member 26 seals the battery case 25. An electrolyte (not shown) is injected into the battery case 25 to impregnate the electrode assembly. The lithium battery 30 may be manufactured by sequentially stacking the positive electrode 23, the negative electrode 22, and the separator 24 to form a stack, rolling the stack, and encasing the rolled stack in the battery case 25. The battery case 25 may be sealed with the sealing member 26, thereby completing the manufacture of the lithium secondary battery 30.

Hereinafter, one or more embodiments of the present invention will be described with reference to the following examples. These examples are presented for illustrative purposes only, and are not intended to limit the purpose and scope of the one or more embodiments of the present invention.

### EXAMPLE 1

### Preparation of Composite Precursor

100 g of nickel sulfate (NiSO₄-6H₂O) 107 g of cobalt sulfate (CoSO₄-7H₂O) 107 g, and 193 g of manganese sulfate (MnSO₄-H₂O) were dissolved in 617 g of water to prepare a precursor mixture.

The precursor mixture and ammonium sulfate were put into a reaction bath and were then stirred at a rate of about 900 rpm at a constant temperature of about 40° C., followed by an addition of sodium carbonate and co-precipitation. The sodium solution was added as a solution in water via an automated pH adjustment by a pH controller to pH 8.

The overflowing slurry was precipitated, washed with pure water, and then dried to prepare the composite precursor, Ni_{0.22}Co_{0.2}Mn_{0.66}(CO₃)₂.

### EXAMPLE 2

### Preparation of Composite

100 g of the co-precipitate, Ni_{0.22}Co_{0.2}Mn_{0.66}(CO₃)₂, obtained in Example 1 was mixed with 47.675 g of Li₂CO₃, and then heated at about 900° C. for about 10 hours to obtain the composite, 0.5Li₂MnO₃-0.5LiNi_{0.44}Co_{0.24}Mn_{0.32}O₂.

### COMPARATIVE EXAMPLE 1

### Preparation of Composite Precursor

A composite precursor was prepared in the same manner as in Example 1, except that ammonium hydroxide (NH₄OH) was used instead of ammonium sulfate.

### COMPARATIVE EXAMPLE 2

### Preparation of Composite

A composite was prepared in the same manner as in Example 1, except that the composite precursor of Comparative Example 1 was used instead of the composite precursor of Example 1.

### MANUFACTURE EXAMPLE 1

### Manufacture of Half Cell

A coin half-cell (2032 type) was manufactured using the composite of Example 2.

92 g of the composite of Example 2, 4 g of polyvinylidene fluoride (PVDF), 106.21 g of N-methylpyrrolidone as a solvent, and 4 g of carbon black as a conducting agent were mixed together using a mixer, followed by degassing to prepare a uniformly dispersed slurry for forming a positive active material layer.

The slurry was coated on an aluminum foil using a doctor blade to form a thin electrode plate, which was then dried at about 135° C. for about 3 hours or longer, followed by pressing and vacuum drying to manufacture a positive electrode.

The positive electrode and lithium metal as a counter electrode were assembled into the coin half-cell (2032 type), along with a porous polyethylene (PE) film separator (having a thickness of about 16 μm) disposed between the positive electrode and the lithium metal counter electrode. An electrolytic solution was injected therein to complete the half cell. The electrolytic solution was a solution of 1.1 M LiPF₆ dissolved in a solvent mixture of ethylene carbonate (EC) and ethylmethyl carbonate (EMC) in a volume ratio of 3:5.

### COMPARATIVE MANUFACTURE EXAMPLE 1

### Manufacture of Half Cell

A coin half-cell was manufactured in the same manner as in Comparative Manufacture Example 1, except that the composite of Comparative Example 2, instead of the composite of Example 2, was used.

### EVALUATION EXAMPLE 1

### Scanning Electron Microscopic (SEM) Analysis

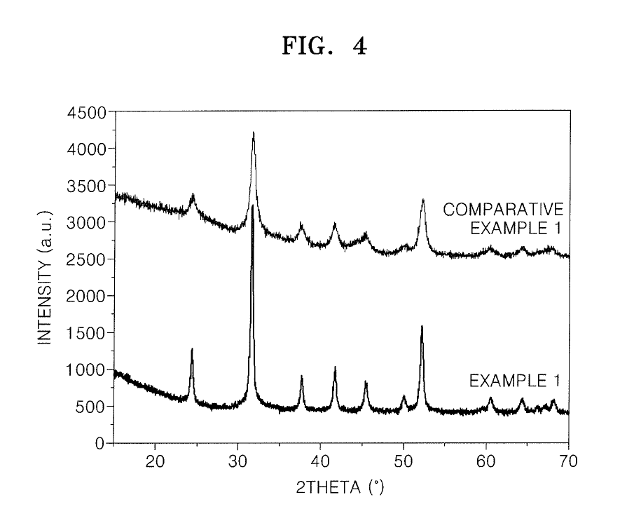

The composite precursors of Example 1 and Comparative Example 1 were analyzed using scanning electron microscopy (SEM). The results are shown in FIGS. 2 and 3, respectively.

As shown in FIGS. 2 and 3, the composite precursor of Example 1 (see FIG. 2) includes primary particles and secondary particles that are smaller in average particle diameter as compared with the composite precursor of Comparative Example 1 (see FIG. 3).

### EVALUATION EXAMPLE 2

### Average Particle Diameter Measurement of Composite Precursor

The average particle diameters of the secondary particles of the composite precursors of Example 1 and Comparative Example 1 were measured. The results are shown in Table 1 below. The average particle diameter measurements were performed using a particle size analyzer.

TABLE 1

| | Average particle diameter of |
|---|---|
| Example | secondary particles (μm) |
| Example 1 | 9.2 |
| Comparative Example 1 | 12.8 |

### EVALUATION EXAMPLE 3

### Tap Density Analysis

The tap densities of the composite precursors of Example 1 and Comparative Example 1 were measured. The results are shown in Table 2 below. The tap density of each composite precursor was measured by filling a mass cylinder with 100 g of the composite precursor and tapping the composite precursor 1000 times with a constant force using a tapping machine at a rate of 150 taps per minute. The tap density was measured as a final volume of the composite precursor after the tapping.

TABLE 2

| Example | Tap density (g/cc) |
|---|---|
| Example 1 | 1.65 |
| Comparative Example 1 | 1.53 |

Referring to Table 2, the composite precursor of Example 1 had a higher tap density than the composite precursor of Comparative Example 1.

### EVALUATION EXAMPLE 4

### Pellet Density Analysis

The pellet densities of the composites of Example 2 and Comparative Example 2 were measured. The results are shown in Table 3 below. The pellet density of each composite was measured as a final volume after applying a pressure of 2.6 t to about 3 g of the composite for 30 seconds.

TABLE 3

| Example | Pellet density (g/cc) |
|---|---|
| Example 2 | 2.55 |
| Comparative Example 2 | 2.47 |

Referring to FIG. 3, the composite of Example 2 had a higher pellet density than the composite of Comparative Example 1.

### EVALUATION EXAMPLE 5

### X-Ray Diffraction (XRD) Analysis

1) Composite Precursors of Example 1 and Comparative Example 1

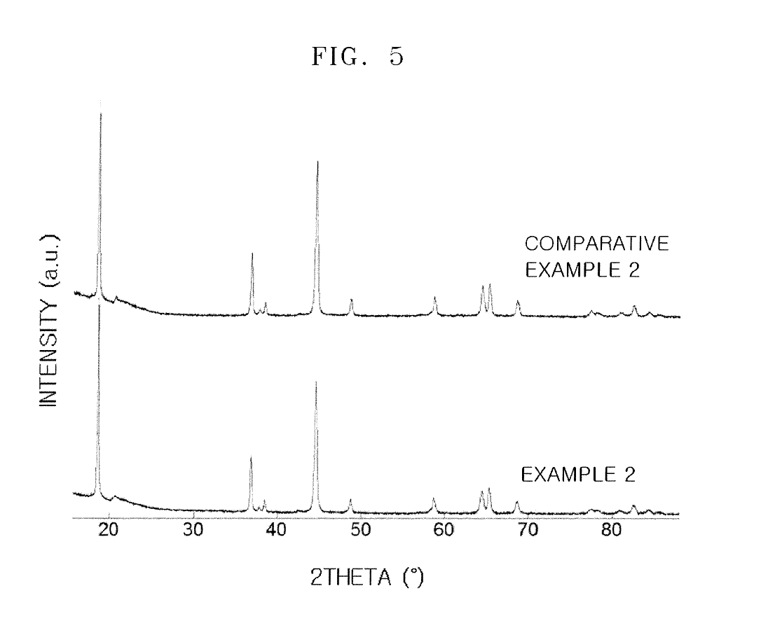

XRD analysis was performed on the composite precursors of Example 1 and Comparative Example 1. The results are shown in FIG. 4.

The full width at half maximum (FWHM) of the peak at about 32° (2θ) was calculated. The results are shown in Table 4 below.

TABLE 4

| Example | FWHM (°) |
|---|---|
| Example 1 | 0.218 |
| Comparative Example 1 | 0.325 |

Referring to FIG. 4 and Table 4, the composite precursor of Example 1 had a smaller FWHM of the peak at about 32° (2θ) than the composite precursor of Comparative Example 1. These results indicate that the composite precursor of Example 1 has improved crystallinity relative to the composite precursor of Comparative Example 1.

2) Composites of Example 2 and Comparative Example 2

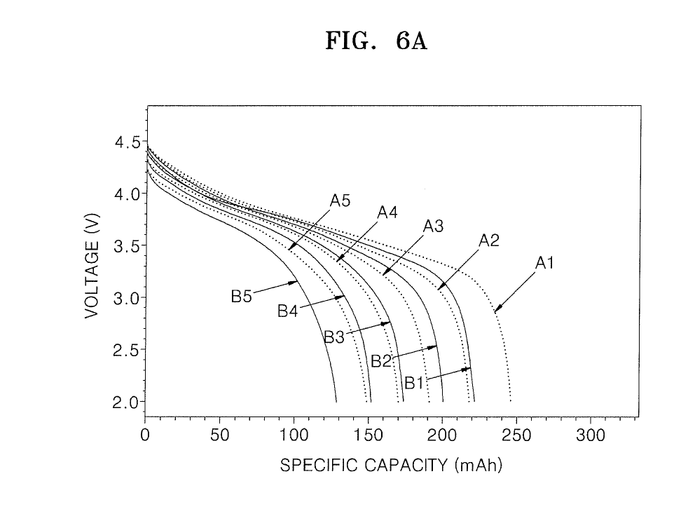

XRD analysis was performed on the composites of Example 2 and Comparative Example 2. The results are shown in FIG. 5.

The FWHM at about 18° (2θ) and peak intensity ratio (I₀₀₃/I₁₀₄) were evaluated. The results are shown in Table 5.

TABLE 5

| Example | FWHM (°) | I₀₀₃/I₁₀₄ |
|---|---|---|
| Example 1 | 0.145 | 1.58 |
| Comparative Example 1 | 0.164 | 1.35 |

In Table 5, I₀₀₃/I₁₀₄ is defined as the ratio of the peak intensity (I₀₀₃) of the peak at about 18° (2θ) to the peak intensity (I₁₀₄) of the peak at about 43° (2θ). This peak intensity ratio of the peak at about 18° (2θ) to the peak at about 43° (2θ) indicates the degree of mixed cations.

### EVALUATION EXAMPLE 6

### Charge-Discharge Test

The charge-discharge characteristics of the coin half cells of Manufacture

Example 1 and Comparative Manufacture Example 1 were evaluated using a charger/discharger (TOYO-3100, available from TOYO System Co. Ltd). The results are shown in Table 6 below.

Each of the coin half cells of Manufacture Example 1 and Comparative Manufacture Example 1 was subjected to one cycle of charging and discharging at a 0.1 C rate for formation, followed by one cycle of charging and discharging at 0.2 C. Afterwards, the initial charge-discharge characteristics of each coin half-cell were evaluated. After a further 50 cycles of charging and discharging at a 1 C rate, the cycle characteristics of each coin half-cell were evaluated. The charging was set to start at a constant current (CC), and then be shifted to a constant voltage (CV) mode to cut off at 0.01 C, and the discharging was set to cut off at 1.5V in a CC mode.

(1) Initial Charge and Discharge Efficiency (I.C.E)

The initial charge efficiency (I.C.E.) of each coin half-cell was calculated using Equation 1 below:

I.C.E (%)=[Discharge capacity at 1^{st} cycle/Charge capacity at 1^{st} cycle]×100 Equation 1

(2) Charge Capacity and Discharge Capacity

The charge capacity and discharge capacity at the 1^{st} cycle of each coin half-cell were measured. The results are shown in Table 6 below.

TABLE 6

| | Charge capacity | Discharge capacity | I.C.E |
|---|---|---|---|
| Example | (mAh/g) | (mAh/g) | (%) |
| Manufacture Example 1 | 316 | 246 | 77.7 |
| Comparative | 288 | 222 | 77.2 |
| Manufacture Example 1 | | | |

Referring to Table 6, the coin half-cell of Manufacture Example 1 had a higher I.C.E than the coin half-cell of Comparative Manufacture Example 1.

### EVALUATION EXAMPLE 7

### Evaluation of Rate Characteristics

The high-rate discharge characteristics of the coin half cells of Manufacture Example 1 and Comparative Manufacture Example 1 were evaluated after charging at a constant current of 0.1 C and a constant voltage of 1.0V (0.01 C cut-off), a rest for about 10 minutes, and then discharging at a variety of constant currents (i.e., 0.1 C, 0.2 C, 0.5 C, 1 C, or 2 C) with a cut-off voltage of 2.5 V.

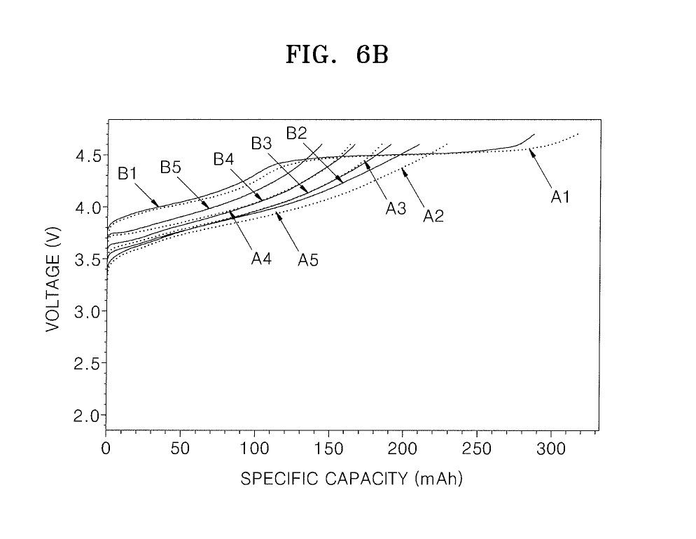

The high-rate discharge characteristics of the coin half cells of Manufacture Example 1 and Comparative Manufacture Example 1 are shown in Table 7, and FIGS. 6A and 6B. FIGS. 6A and 6B are graphs of the charge-discharge voltages with respect to time of the coin half cells (A1-A5, and B1-B5) of Manufacture Example 1 and Comparative Manufacture Example 1 at the different conditions. In FIGS. 6A and 6B, A1 through A5 and B1 through B5 are defined as follows:

A1: Coin half-cell of Manufacture Example 1 at 0.1 C

A2: Coin half-cell of Manufacture Example 1 at 0.2 C

A3: Coin half-cell of Manufacture Example 1 at 0.5 C

A4: Coin half-cell of Manufacture Example 1 at 1 C

A5: Coin half-cell of Manufacture Example 1 at 2 C

B1: Coin half-cell of Comparative Manufacture Example 1 at 0.1 C

B2: Coin half-cell of Comparative Manufacture Example 1 at 0.2 C

B3: Coin half-cell of Comparative Manufacture Example 1 at 0.5 C

B4: Coin half-cell of Comparative Manufacture Example 1 at 1 C

B5: Coin half-cell of Comparative Manufacture Example 1 at 2 C

The high-rate discharge characteristics in Table 7 were calculated using Equation 2 below.

High-rate discharge characteristic (%)=[(Discharge capacity of cell at a discharge rate of 1 C)/(Discharge capacity of cell at a discharge rate of 0.1 C)]*100 Equation 1

TABLE 7

| | Manufacture | Comparative Manufacture |
|---|---|---|
| Characteristics | Example 1 | Example 1 |
| Discharge capacity | 218 | 200 |
| (mAh/g) | | |
| (0.2 C) | | |
| Discharge capacity | 191 | 173 |
| (mAh/g) | | |
| (0.5 C) | | |
| Discharge capacity | 170 | 151 |
| (mAh/g) | | |
| (1 C) | | |
| Discharge capacity | 148 | 128 |
| (mAh/g) | | |
| (2 C) | | |
| High-rate discharge | 69.1 | 68.0 |
| characteristic (1 C/0.1 C)(%) | | |

Referring to Table 7 and FIGS. 6A and 6B, the coin half cells of Manufacture Example 1 had improved discharge characteristics at high rates as compared to the coin half cells of Comparative Manufacture Example 1.

As described above, according to one or more embodiments of the present invention, a composite with improved capacity may be prepared from a composite precursor having a controlled particle diameter and thus a high tap density. A lithium secondary battery with improved charge-discharge characteristics and high rate characteristics may be manufactured using the composite.

It should be understood that the exemplary embodiments described herein are presented for illustrative purposes only, and not for purposes of limitation. Descriptions of features or aspects within each embodiment should typically be considered as available for other similar features or aspects in other embodiments. Also, while certain exemplary embodiments of the present invention have been illustrated and described, those of ordinary skill in the art would understand that various modifications to the described embodiments could be made without departing from the spirit and scope of the present invention, as defined in the appended claims.

What is claimed is:

1. A composite precursor represented by Formula 1 and comprising primary particles having an average particle diameter of about 1 nm to about 10 nm:
NiₐMn_{b}Co_{c}M_{d}(CO₃)₂ Formula 1
wherein 0<a≦0.5, 0<b≦0.8, 0<c≦0.5, 0≦d≦0.20, and M is at least one metal selected from the group consisting of titanium (Ti) vanadium (V), chromium (Cr), iron (Fe), copper (Cu), aluminum (Al), magnesium (Mg), zirconium (Zr), and boron (B).

2. The composite precursor of claim 1, wherein the composite precursor has a tap density of about 1.55 to about 1.8 g/cc.

3. The composite precursor of claim 1, wherein X-ray diffraction spectra of the composite precursor obtained using Cu—Kα X-rays include a peak with a full width at half maximum (FWHM) of about 0.21 to 0.30° at a 2θ of 32±2°.

4. The composite precursor of claim 1, wherein 0<a≦0.22, 0<b≦0.66, 0<c≦0.20, and 0≦d≦0.10.

5. The composite precursor of claim 1, wherein the composite precursor is Ni_{0.22}Co_{0.12}Mn_{0.66}(CO₃)₂.

6. The composite precursor of claim 1, further comprising secondary particles having an average particle diameter of about 5 μm to about 10 μm.

7. A composite represented by Formula 2, wherein X-ray diffraction spectra of the composite obtained using Cu—Kα X-rays include a peak with a full width at half maximum (FWHM) of about 0.14 to 0.16° at a 2θ of 19±2°:
xLi₂MnO₃-(1-x)Li_{y}NiₐMn_{b}Co_{c}M_{d}O₂ Formula 2
wherein 0<x≦0.8, 0.7≦y≦1.3, 0<a≦0.5, 0<b≦0.8, 0<c≦0.5, 0≦d≦0.20, M is at least one metal selected from the group consisting of titanium (Ti) vanadium (V), chromium (Cr), iron (Fe), copper (Cu), aluminum (Al), magnesium (Mg), zirconium (Zr), and boron (B).

8. The composite of claim 7, wherein the composite has a pellet density of about 2.4 to about 2.6 g/cc.

9. The composite of claim 7, wherein 0<x≦0.5, 0.9≦y≦1.1, 0<a≦0.44, 0<b≦0.33, 0<c≦0.33, and 0≦d≦0.10.

10. The composite of claim 7, wherein the composite is 0.5Li₂MnO₃-0.5LiNi_{0.44}Co_{0.24}Mn_{0.32}O₂.

11. A method of preparing a composite represented by Formula 2, the method comprising: mixing a composite precursor represented by Formula 1 with a lithium compound to obtain a mixture, and thermally treating the mixture to obtain the composite:
NiₐMn_{b}Co_{c}M_{d}(CO₃)₂ Formula 1
wherein, in Formula 1, 0<a≦0.5, 0<b≦0.8, 0<c≦0.5, 0≦d≦0.20, and M is at least one metal selected from the group consisting of titanium (Ti) vanadium (V), chromium (Cr), iron (Fe), copper (Cu), aluminum (Al), magnesium (Mg), zirconium (Zr), and boron (B),
xLi₂MnO₃-(1-x)Li_{y}NiₐMn_{b}Co_{c}M_{d}O₂ Formula 2
wherein, in Formula 2, 0<x≦0.8, 0.7≦y≦1.3, 0<a≦0.5, 0<b≦0.8, 0<c≦0.5, 0≦d≦0.20, and M is at least one metal selected from the group consisting of titanium (Ti) vanadium (V), chromium (Cr), iron (Fe), copper (Cu), aluminum (Al), magnesium (Mg), zirconium (Zr), and boron (B).

12. The method of claim 11, further comprising preparing the composite precursor represented by Formula 1 by mixing a nickel precursor, a cobalt precursor, a manganese precursor, a metal (M) precursor, and a solvent to prepare a precursor mixture; and mixing the precursor mixture, an acidic ammonium-containing compound, and sodium carbonate to obtain a precursor reaction mixture, and co-precipitating the mixture.

13. The method of claim 12, wherein the acidic ammonium-containing compound is ammonium sulfate.

14. The method of claim 12, wherein a pH of the precursor reaction mixture is about 7 to about 9.

15. The method of claim 11, wherein the thermally treating the mixture comprises heating the mixture at a temperature of about 700° C. to about 900° C.

16. A positive electrode for a lithium secondary battery, comprising the composite represented by Formula 2, wherein X-ray diffraction spectra of the composite obtained using Cu—Kα X-rays include a peak with a full width at half maximum (FWHM) of about 0.14 to 0.16° at a 2θ of 19±2°.
xLi₂MnO₃-(1-x)Li_{y}NiₐMn_{b}Co_{c}M_{d}O₂ Formula 2
wherein 0<x≦0.8, 0.7≦y≦1.3, 0<a≦0.5, 0<b≦0.8, 0<c≦0.5, 0≦d≦0.20, and M is at least one metal selected from the group consisting of titanium (Ti) vanadium (V), chromium (Cr), iron (Fe), copper (Cu), aluminum (Al), magnesium (Mg), zirconium (Zr), and boron (B).

17. The positive electrode of claim 16, wherein the composite has a pellet density of about 2.4 to about 2.6 g/cc.

18. The positive electrode of claim 16, wherein 0<x≦0.5, 0.9≦y≦1.1, 0<a≦0.44, 0<b≦0.33, 0<c≦0.33, and 0≦d≦0.10.

19. The positive electrode of claim 16, wherein the composite is 0.5Li₂MnO₃-0.5LiNi_{0.44}Co_{0.24}Mn_{0.32}O₂.

20. A lithium secondary battery comprising the positive electrode of claim 16, an anode, and a separator between the positive electrode and the anode.
